(19) United States
(12) Patent Application Publication
(10) Pub. No.: US 2007/0146193 A1
(43) Pub. Date: Jun. 28, 2007

(54) Remote control device and information reproducing system

(75) Inventors: Shojiro Sato, Kawasaki-shi (JP); Toshikazu Mochizuki, Hamura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/635,684

(22) Filed: Dec. 8, 2006

(30) Foreign Application Priority Data
Dec. 16, 2005 (JP) 2005-363465

(51) Int. Cl. G08C 19/12

(52) U.S. Cl. 341/176; 348/734; 345/169; 340/825.72; 386/125

(57) ABSTRACT

A remote control device of the present invention is equipped with a plurality of direction keys corresponding to a plurality of switches equally divided in a main body portion of the device. Moreover, in a case where the respective direction keys are individually operated, data in response to the operated direction key is transmitted from a light emitting section. In a case where one of the plurality of direction keys is operated simultaneously with one direction key adjacent to the direction key, data corresponding to a direction key disposed between the direction keys is transmitted.

### CROSS-REFERENCE TO RELATED APPLICATIONS

This application is based upon and claims the benefit of priority from Japanese Patent Application No. 2005-363465, filed Dec. 16, 2005, the entire contents of which are incorporated herein by reference.

### BACKGROUND

1. Field

The present invention relates to a remote control device and an information reproducing system, more particularly to an improvement in an operation button of a remote control device which operates an information reproducing device such as a DVD player.

2. Description of the Related Art

Heretofore, a multifunctional remote control device has been put to practical use which is capable of operating a plurality of units such as a television and a VTR with one device. Moreover, such a remote control device is provided with a main switch and a sub-switch in order to select and determine multifunctional items.

For example, in Jpn. Pat. Appln. KOKAI Publication No. 10-174183, a technology is disclosed in which a main switch as a direction key includes: one contact divided into a large number of circumferentially arranged contacts; and the other contact that is annular, and the main switch is depressed to thereby bring the one contact into contact with the other contact. In this remote control device, there is obtained a position of the switch in a state in which a plurality of contacts are pressed or a single contact is pressed, and information on the contact position of the main switch is obtained. Moreover, when the plurality of contacts are pressed, the center of a plurality of contact portions is obtained as the position of the switch. In the case where an even number of the contacts are pressed, however, one of two switches in the center is obtained as the position of the switch in accordance with a predetermined rule.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing an appearance of a remote control device in a first embodiment of the present invention;

FIG. 2 is an explanatory view in a case where a DVD player 30 is operated using a remote control device 10 of FIG. 1;

FIG. 3 is an explanatory view showing contacts corresponding to a direction button 16 and a determine button 18 of FIG. 1;

FIG. 4 is a circuit block diagram showing a schematic constitution of key switches constituting the direction button 16 of the remote control device and a peripheral portion of the switches;

FIG. 5 is a flowchart showing an operation to detect a direction key in the remote control device 10 in a first embodiment of the present invention;

FIG. 6 is a flowchart showing an operation to calculate transmission data in the remote control device 10 in the first embodiment of the present invention;

FIG. 7 is a flowchart showing an operation to detect a direction key of a remote control device in a second embodiment of the present invention;

FIG. 8 is a table showing counting of the direction key;

FIG. 9 is a flowchart showing an operation to calculate transmission data of the remote control device 10 in the second embodiment of the present invention;

FIG. 10 is a flowchart showing an operation to calculate transmission data of a remote control device in a third embodiment of the present invention;

FIG. 11 is a flowchart showing an operation to calculate transmission data of a remote control device in a fourth embodiment of the present invention; and

FIG. 12 is a flowchart showing an operation to calculate the predetermined number of times in a remote control device in a fifth embodiment of the present invention.

### DETAILED DESCRIPTION

Various embodiments according to the invention will be described hereinafter with reference to the accompanying drawings. In general, according to one embodiment of the invention, there is provided a remote control device equipped with a plurality of direction keys which are flat and which are equally divided, and in a case where the respective direction keys are individually operated, the remote control device being configured to transmit data in response to the operated direction key, the remote control device comprising a control section in which in a case where one of the plurality of direction keys is operated simultaneously with one direction key adjacent to the direction key, control is performed to transmit data different from data of the direction key.

### First Embodiment

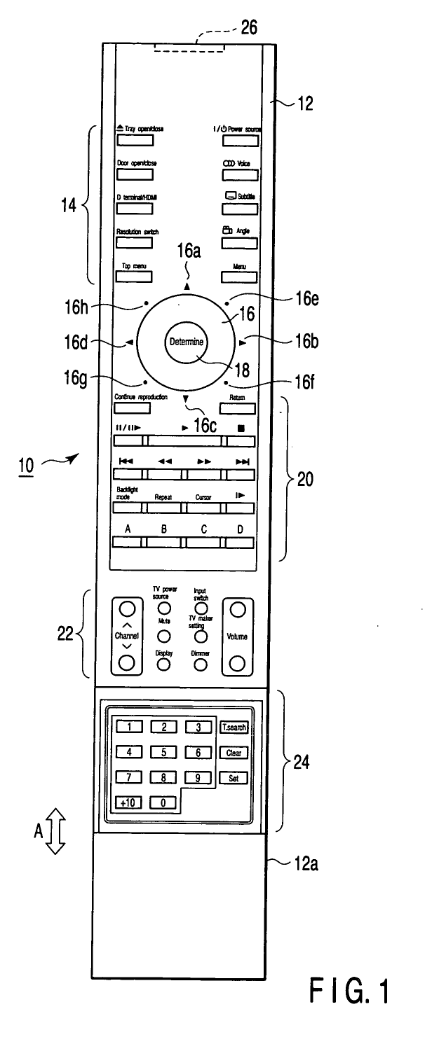

FIG. 1 is a diagram showing an appearance of a remote control device in a first embodiment of the present invention.

This remote control device can control two types of units such as a DVD player and a television which are reproducing devices.

In FIG. 1, on an operation face of a main body portion 12 of the remote control device 10, there are arranged an operation button group 14, a direction button 16 and a determine button 18, and operation button groups 20, 22 and 24. Moreover, in the front (upper side in FIG. 1) of the remote control device 10, there is disposed a light emitting portion 26 in which an infrared LED or the like is built. When a user depresses a button as each type of key, an infrared signal is transmitted from the light emitting portion 26 to a unit (not shown). Further in the remote control device 10, a known vibration sensor is built as means for detecting a vibration to be applied to the remote control device 10. Furthermore, on a side opposite to the operation face of the remote control device 10, a cell storage section (not shown) is disposed to charge a cell which drives the remote control device 10.

It is to be noted that this remote control device 10 is constituted to light a backlight, when each type of button is operated by the user. Even in a case where the vibration is detected by the vibration sensor, the backlight is constituted to also light. This backlight is constituted to automatically turn off with an elapse of a predetermined time.

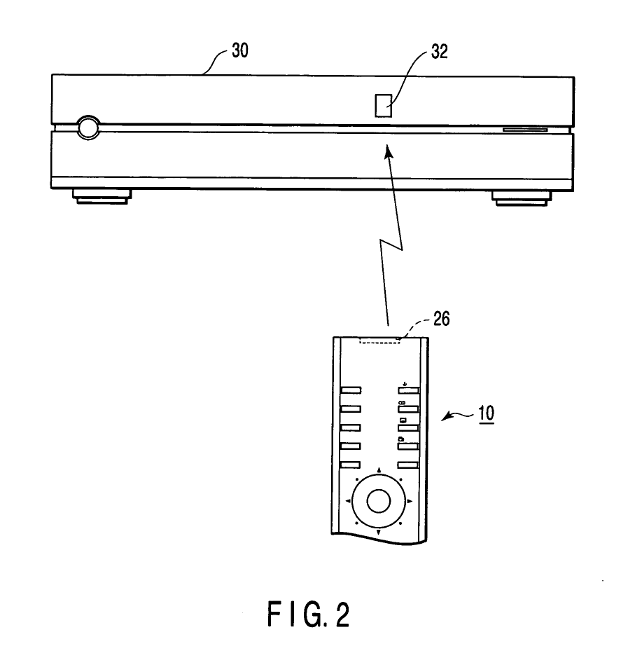

The operation button group 14 relates to a function of setting a DVD player 30 shown in, for example, FIG. 2. When the operation button group 14 is depressed by the user, various types of settings of the DVD player 30 are performed.

Moreover, the direction button 16 as a direction key moves a cursor displayed in a television screen (not shown). The direction button 16 is flat and is divided into eight equal portions. In the remote control device 10 of the present embodiment, the direction button is divided into eight directions as shown, including: an upper direction (key) 16a; an obliquely upper right direction (key) 16e; a right direction (key) 16b; an obliquely lower right direction (key) 16f; a lower direction (key) 16c; an obliquely lower left direction (key) 16g; a left direction (key) 16d; and an obliquely upper left direction (key) 16h. These eight directions are designated as described later, whereby the cursor in the television screen moves. Moreover, the determine button 18 has a function of indicating item determination. That is, after the direction buttons 16a to 16h are operated, the determine button 18 is depressed, whereby there is determined an item in a position where the cursor is displayed.

The operation button group 20 is constituted of a plurality of buttons concerning an operation of the DVD player. The operation button group 22 includes television operating buttons, and the operation button group 24 includes number input buttons and associated buttons. This operation button group 24 is usually covered with a lid 12a which is slidable in a shown arrow A direction so that the operation face of the main body portion 12 is not seen. In a case where the user performs input into the operation button group 24, the user slides the lid 12a to expose the operation button group 24.

FIG. 2 is an explanatory view in a case where the DVD player 30 is operated as an information reproducing device by use of the present remote control device 10.

On a front portion of the DVD player 30 as the information reproducing device, a remote control light receiving portion 32 is disposed to receive a signal from the remote control device 10. Moreover, the user directs the light emitting portion 26 of the remote control device 10 with respect to the remote control light receiving portion 32 of the DVD player 30 with a predetermined distance and a predetermined angle, and presses a desired button among the above operation button groups 14, 20, 22 and 24, the direction button 16 and the determine button 18. Then, a signal corresponding to a function of the pressed button is transmitted from the light emitting portion 26 toward the remote control light receiving portion 32. Accordingly, in the DVD player 30, an operation of the function desired by the user is executed.

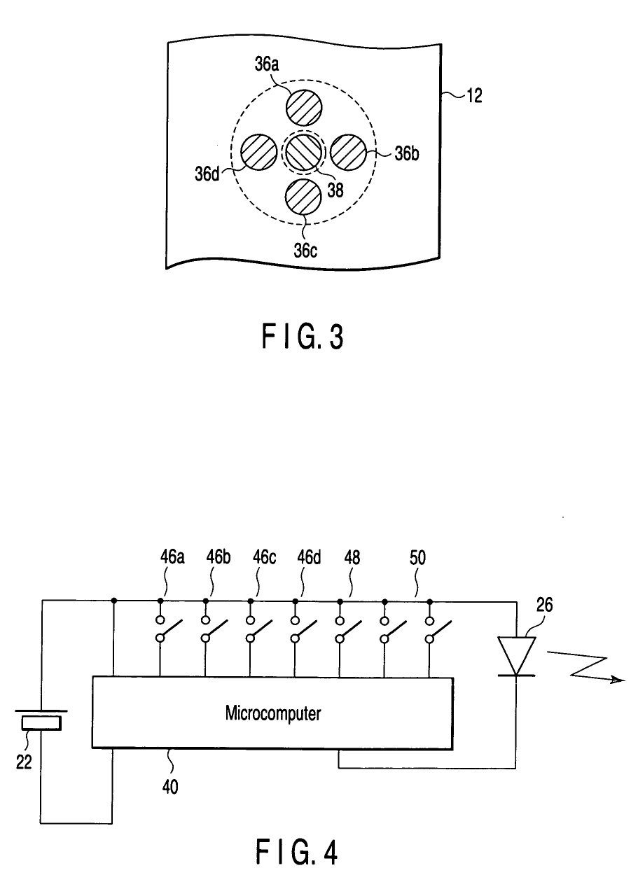

FIG. 3 is an explanatory view showing contacts corresponding to the direction button 16 and the determine button 18.

On a substrate (not shown) of the main body portion 12, four contacts 36a, 36b, 36c and 36d are circumferentially arranged which correspond to key positions of the above upper key 16a, the right key 16b, the lower key 16c and the left key 16d. Similarly, in the center of four contacts 36a, 36b, 36c and 36d, a contact 38 is disposed which corresponds to a position of the determine button 18. Moreover, in positions facing these contacts 36a, 36b, 36c and 36d and the contact 38, that is, on the backside of the operation face of the main body portion 12, there are arranged annular contacts and a circular contact (not shown). That is, the contacts 36a, 36b, 36c and 36d and the annular contacts (not shown), and the contact 38 and the circular contact (not shown) are constituted as pairs of key switches, respectively.

FIG. 4 is a circuit block diagram showing a schematic constitution of the key switches constituting the direction button 16 of this remote control device 10 and a peripheral portion of the switches.

In FIG. 4, a microcomputer 40 is control means (detection control means) which performs a control operation of the remote control device 10, such as reading of the key corresponding to each type of button or remote control transmitting. Moreover, this microcomputer 40 is connected to a cell 42 as a power source, a light emitting diode as transmission means constituting the light emitting portion 26, switches 46a to 46d, 48 and 50.

The switches 46a, 46b, 46c and 46d correspond to the upper key 16a, the right key 16b, the lower key 16c and the left key 16d of the above direction button 16, and the switch 48 is a switch corresponding to the determine button 18. In FIG. 4, the switch 50 is representatively shown as another switch. It is to be noted that the switches corresponding to the above obliquely upper right key 16e, the obliquely lower right key 16f, the obliquely lower left key 16g and the obliquely upper left key 16h do not exist in an electric circuit. Therefore, as described later in detail, the switches exist as data between adjacent directions in control specifications.

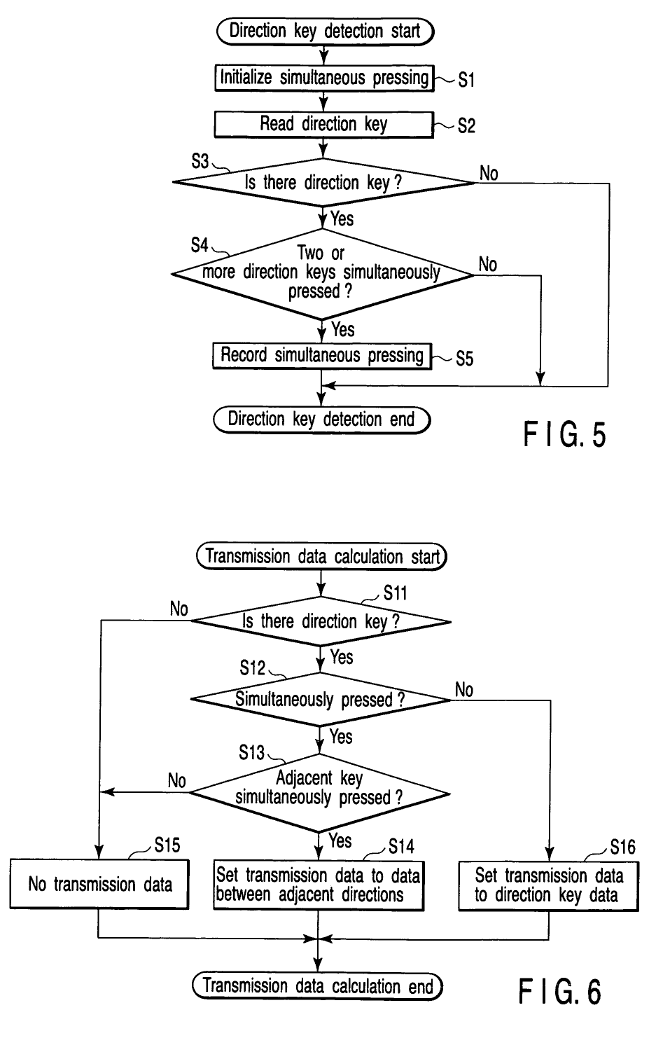

Next, there will be described an operation to detect the direction key in the remote control device 10 in the first embodiment of the present invention with reference to a flowchart of FIG. 5. It is to be noted that the following operation of this remote control device 10 is performed mainly under control of the microcomputer 40.

When the present routine is started, first in step S1, there is initialized “simultaneous pressing” information set in a case where the direction keys have simultaneously been pressed. Thereafter, in step S2, the microcomputer 40 reads information of the upper key 16a, the right key 16b, the lower key 16c and the left key 16d. Subsequently, it is judged in step S3 whether or not any of the above direction keys has been pressed.

Here, when no direction key is pressed, the flow goes out of the routine as it is. On the other hand, in a case where any of the direction keys is pressed, it is judged in the subsequent step S4 whether or not two or more direction keys have simultaneously been pressed. As a result, in a case where it is judged that two or more direction keys are pressed, the flow shifts to step S5. After the “simultaneous pressing” information is set, the flow goes out of the present routine. In a case where it is judged in the step S4 that two or more direction keys are not simultaneously pressed, the step S5 is skipped.

Next, there will be described an operation to calculate transmission data in the remote control device 10 in the first embodiment of the present invention with reference to a flowchart of FIG. 6.

When the present routine is started, it is first judged in step S11 whether or not any direction key has been pressed. Here, when no direction key is pressed, the flow shifts to step S15, and goes out of the routine without setting any transmission data. On the other hand, in a case where it is judged in the step S11 that any direction key is pressed, the flow shifts to step S12 to judge whether or not the direction keys are simultaneously pressed. As a result, in a case where it is judged that the direction keys are not simultaneously pressed, that is, in a case where a certain direction key is pressed but no simultaneous pressing information is set, the flow shifts to step S16 to set the pressed direction key as the transmission data.

On the other hand, in a case where it is judged in the step S12 that the direction keys are simultaneously pressed, the flow shifts to step S13 to judge whether or not adjacent keys are simultaneously pressed. Here, in a case where the pressed keys are a combination of the upper key 16a and the lower key 16c or a combination of the right key 16b and the left key 16d which are not the adjacent keys, the flow shifts to the step S15, chattering or double pressing is judged, and it is judged that there is not any transmission data. On the other hand, in a case where the direction key is pressed, and the adjacent key is simultaneously pressed, the flow shifts to step S14, and the transmission data is set as data between the adjacent directions. For example, in a case where the upper key 16a and the right key 16b are simultaneously pressed, the data is set as the obliquely upper right key 16e.

As described above, according to the first embodiment, eight direction data can be identified and transmitted with four direction keys having four contacts.

### Second Embodiment

Next, a second embodiment of the present invention will be described.

In the above first embodiment, in a case where the adjacent direction keys are simultaneously pressed, the data is set as the key between both of the direction keys. In this second embodiment, there will be described identification of a key direction in a case where three or more keys are simultaneously pressed.

It is to be noted that a constitution and a basic operation of a remote control device in the second embodiment are the same as those of the remote control device of the first embodiment shown in FIGS. 1 to 4. Therefore, the same part is denoted with the same reference numeral, drawing and description thereof are omitted, and only a different part will be described.

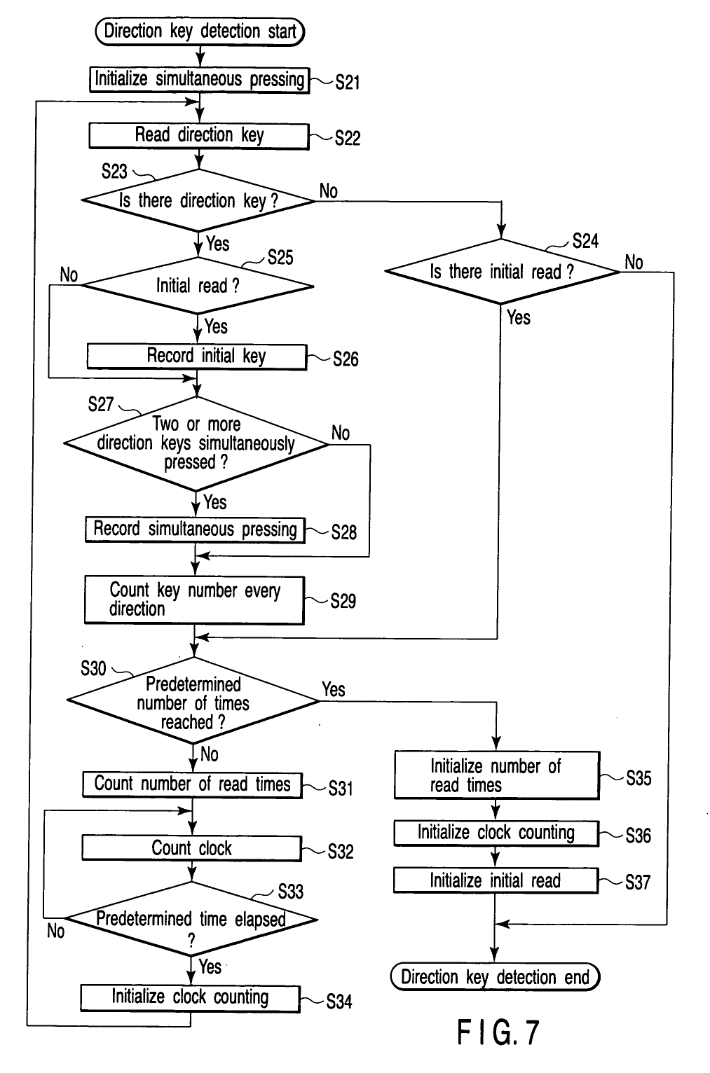

There will be described hereinafter an operation to detect a direction key in the remote control device in the second embodiment of the present invention with reference to a flowchart of FIG. 7.

When the present routine is started, first in step S21, there is initialized “simultaneous pressing” information set in a case where the direction keys have simultaneously been pressed. Thereafter, in step S22, a microcomputer 40 reads information of an upper key 16a, a right key 16b, a lower key 16c and a left key 16d. Subsequently, it is judged in step S23 whether or not any of the direction keys has been pressed.

In a case where it is judged in this step S23 that no direction key is pressed, the flow shifts to step S24 to judge whether or not the direction key is initially read. Here, in a case where it is judged that there is the initial read, the flow shifts to step S30 described later. In a case where there is not any initial read, the flow goes out of the present routine.

On the other hand, in a case where it is judged in the step S23 that the direction key is pressed, the flow shifts to step S25 to judge whether or not the direction key is initially read. Here, in a case where it is judged that there is the initial read, the flow shifts to step S26, and “initial key” is recorded in a memory (not shown). In a case where it is judged in the step S25 that there is not any initial read, the step S26 is skipped.

Moreover, it is judged in step S27 whether or not two or more direction keys have simultaneously been pressed. As a result, in a case where it is judged that two or more direction keys are pressed, the flow shifts to step S28. After the “simultaneous pressing” information is set, the flow goes out of the present routine. In a case where it is judged in the step S27 that two or more direction keys are not simultaneously pressed, the step S28 is skipped. In step S29, the number of key press times is counted every key direction.

Next, it is judged in the step S30 whether or not the counted number of the times has reached the predetermined number of the times. Here, in a case where it is judged that the predetermined number of the times is not reached, the flow shifts to step S31 to count the number of read times. Furthermore, in step S32, the counting is started by a clock function (not shown) of the microcomputer 40. Moreover, steps S32 and S33 are repeated until it is judged in step S33 that a predetermined time has elapsed. When it is judged in the step S33 that the predetermined time has elapsed, the flow shifts to step S34 to initialize the clock counting, the flow shifts to the step S22, and the direction key is read again in the present routine.

In a case where it is judged in the step S30 that the predetermined number of the times is not reached, the flow shifts to step S35 to initialize the number of the read times. Next, in step S36, the clock counting is initialized. Further in step S37, the initial read is initialized. Thereafter, the present routine ends.

That is, in the present routine, there is recorded the key which has been pressed the predetermined number of the times every predetermined time.

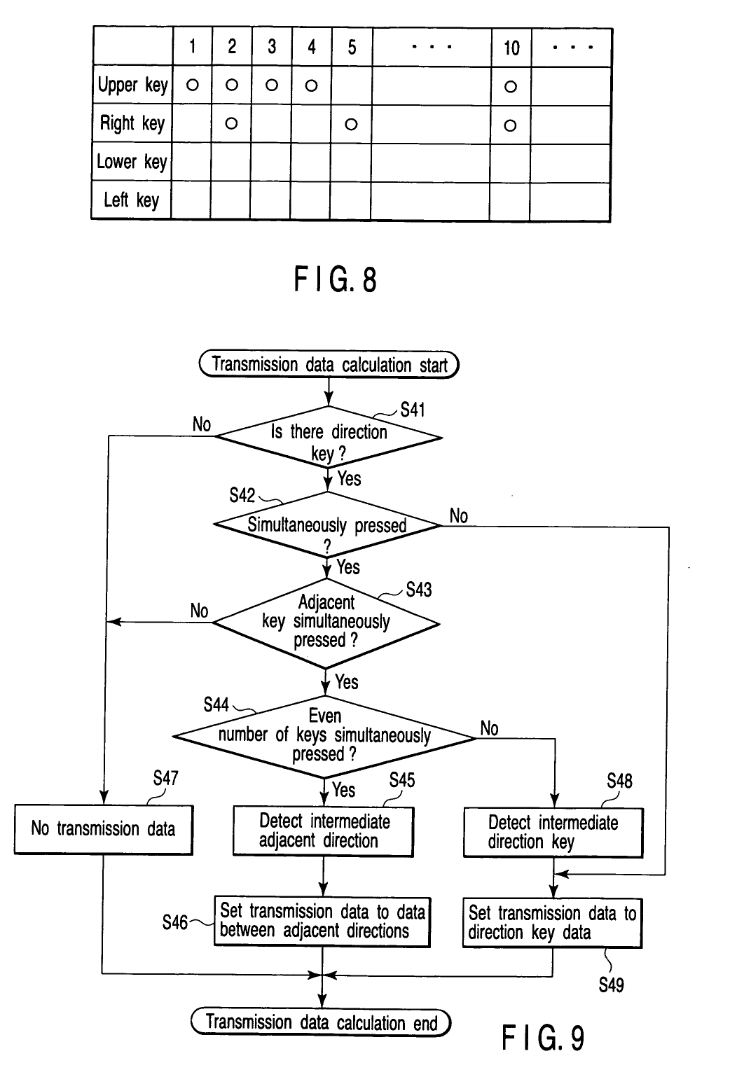

Here, the counting of the direction key will be described with reference to a table of FIG. 8.

As shown in, for example, FIG. 8, there is counted the number of times when the upper key 16a, the right key 16b, the lower key 16c or the left key 16d has been pressed for a predetermined time of, for example, 100 msec. Moreover, in a case where the key is counted, for example, ten or more times for the predetermined time, it is judged that the key has been pressed. In a remote control device 10, such a table is prepared in a memory (not shown) to detect the key.

Next, there will be described an operation to calculate transmission data in the remote control device 10 in the second embodiment with reference to a flowchart of FIG. 9.

When the present routine is started, it is first judged in step S41 whether or not any direction key has been pressed. Here, when no direction key is pressed, the flow shifts to step S47, and goes out of the routine without setting any transmission data. On the other hand, in a case where it is judged that the direction key is pressed, the flow shifts to step S42 to judge whether or not the direction keys are simultaneously pressed. As a result, in a case where it is judged that the direction keys are not simultaneously pressed, that is, in a case where the direction key is pressed but no simultaneous pressing information is set, the flow shifts to step S49 to set the pressed direction key as the transmission data.

On the other hand, in a case where it is judged in step S42 that the direction keys are simultaneously pressed, the flow shifts to step S43 to judge whether or not adjacent keys are simultaneously pressed. Here, in a case where the pressed keys are a combination of the upper key 16a and the lower key 16c or a combination of the right key 16b and the left key 16d which are not the adjacent keys, the flow shifts to step S47, chattering or double pressing is judged, and it is judged that there is not any transmission data. On the other hand, in a case where the direction key is pressed, and the adjacent key is simultaneously pressed, the flow shifts to step S44 to detect the number of the simultaneously pressed keys.

In a case where it is judged in this step S44 that an even number of direction keys are simultaneously pressed, the flow shifts to step S45 to regard an adjacent position between the keys as an intermediate position. Moreover, in step S46, the transmission data is set as data between the adjacent directions. For example, in a case where the upper key 16a and the right key 16b are simultaneously pressed the same number of the times, an obliquely upper right key 16e is set as the direction key positioned between both of the keys.

Moreover, in a case where it is judged in step S44 that an odd number of direction keys are simultaneously pressed, the flow shifts to step S48 to detect an intermediate direction key among the pressed keys. Moreover, in the subsequent step S49, this intermediate direction key is set as the transmission data. In a case where, for example, the upper key 16a, the right key 16b and the lower key 16c are simultaneously pressed, there is set the right key 16b positioned in the center of the three keys.

As described above, according to the second embodiment, data on the eight directions is identified with the direction keys. Moreover, in a case where the adjacent keys are simultaneously pressed, the data is identified and transmitted as the direction key of the intermediate position.

### Third Embodiment

Next, a third embodiment of the present invention will be described.

In the above second embodiment, in a case where three or more keys are simultaneously pressed, the direction key in the intermediate position is identified. In this third embodiment, it is judged whether or not the number of times when the adjacent keys are simultaneously pressed has reached a predetermined ratio, and accordingly different data is transmitted.

It is to be noted that a constitution and a basic operation of a remote control device in the third embodiment are the same as those of the remote control device of the first embodiment shown in FIGS. 1 to 4. Therefore, the same part is denoted with the same reference numeral, drawing and description thereof are omitted, and only a different part will be described.

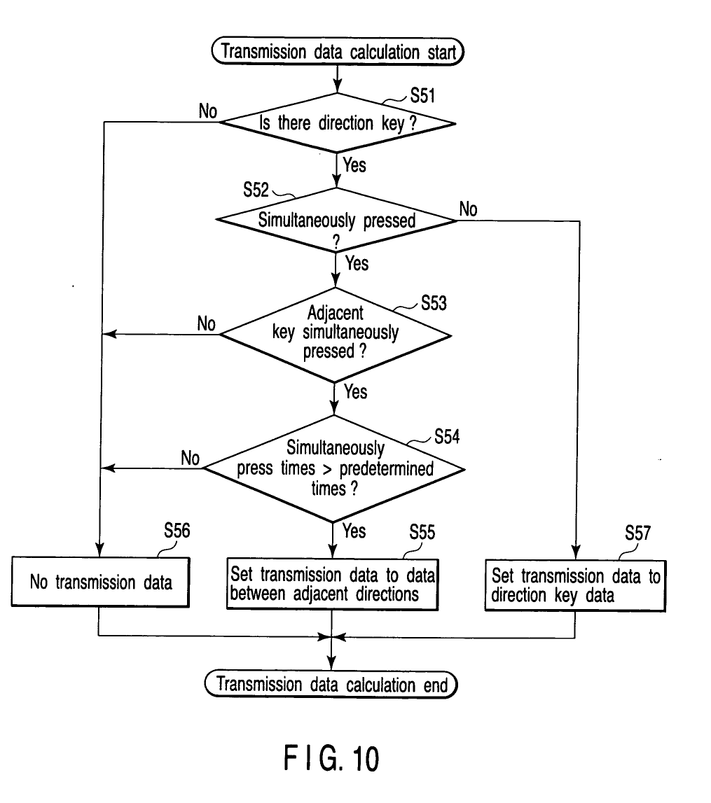

There will be described hereinafter an operation to calculate transmission data of the remote control device in the third embodiment of the present invention with reference to a flowchart of FIG. 10. In this routine, there is used direction key data read in step S22 of reading the direction key in the flowchart of FIG. 7.

It is to be noted that in the flowchart of FIG. 10, processing operations of steps S51 to S53, S55, S56 and S57 are the same as those of steps S41 to S43, S46, S47 and S49 of the flowchart of FIG. 9, therefore the corresponding step numbers are referred to, and the description is omitted herein.

In a case where it is judged in step S53 that adjacent keys are simultaneously pressed, the flow shifts to step S54 to judge whether or not the number of the simultaneous press times is the predetermined number of the times or more. Here, in a case where the number of the simultaneous press times does not reach the predetermined number of the times or more, that is, a predetermined ratio or more, it is judged that an obliquely upper right key 16e, an obliquely lower right key 16f, an obliquely lower left key 16g or an obliquely upper left key 16h disposed in a data position between adjacent directions is not pressed, and any of four direction keys of an upper key 16a, a right key 16b, a lower key 16c and a left key 16d is pressed twice (i.e., intentional double pressing). Therefore, in this case, the flow shifts to step S56 to judge that there is not any transmission data. On the other hand, in a case where it is judged in step S54 that the number of the simultaneous press times reaches the predetermined number of the times or more, that is, the predetermined ratio or more, the flow shifts to step S55 to set the transmission data as data between adjacent directions.

As described above, according to the third embodiment, even when the adjacent direction keys are simultaneously pressed, when the number of the press times is less than the predetermined ratio, this data is not accepted.

### Fourth Embodiment

Next, a fourth embodiment of the present invention will be described.

In the above third embodiment, in a case where the number of times when adjacent keys are simultaneously pressed is less than predetermined number of the times, this data is not accepted. In this fourth embodiment, however, in a case where the number of the times does not reach the predetermined number of the times, data is transmitted in accordance with a ratio of the pressed key.

It is to be noted that a constitution and a basic operation of a remote control device in the fourth embodiment are the same as those of the remote control device of the first embodiment shown in FIGS. 1 to 4. Therefore, the same part is denoted with the same reference numeral, drawing and description thereof are omitted, and only a different part will be described.

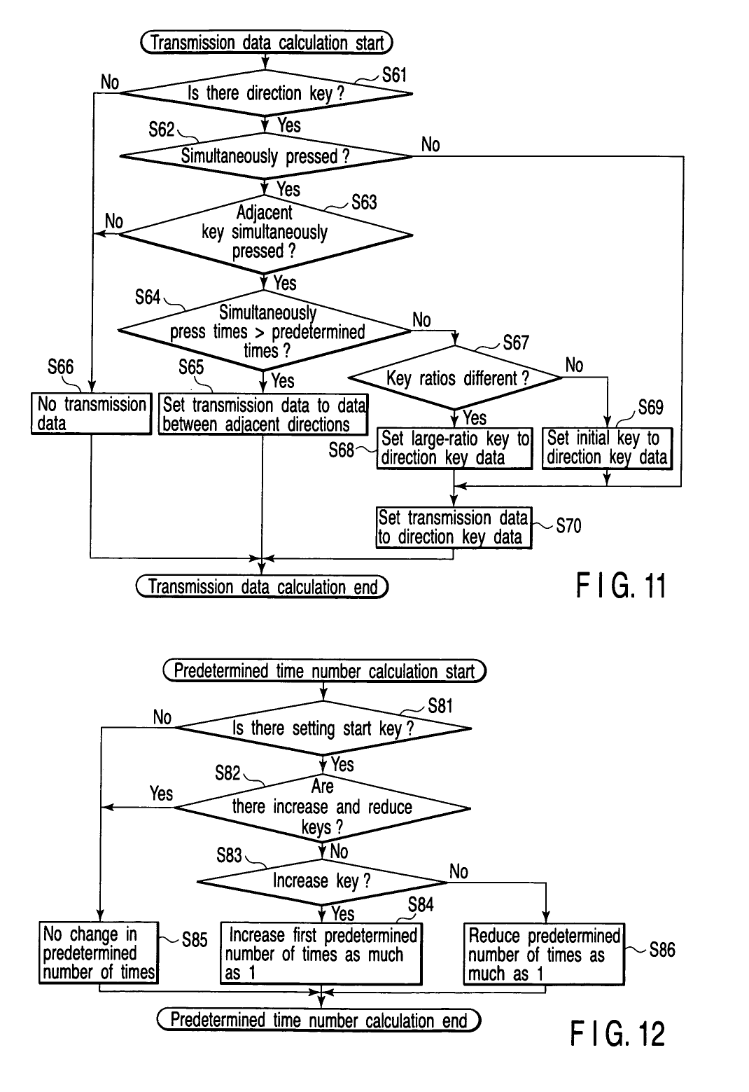

There will be described hereinafter an operation to calculate transmission data in the remote control device in the fourth embodiment of the present invention with reference to a flowchart of FIG. 11. In this routine, there is used direction key data read in step S22 of reading the direction key in the flowchart of FIG. 7.

It is to be noted that in the flowchart of FIG. 11, processing operations of steps S61 to S66 and S70 are the same as those of steps S51 to S56 and S57 of the flowchart of FIG. 10, therefore the corresponding step numbers are referred to, and the description is omitted herein.

In a case where it is judged in step S64 that the number of simultaneous press times does not reach the predetermined number of the times or more, that is, a predetermined ratio or more, the flow shifts to step S67, and ratios of the simultaneously pressed direction keys are detected. In a case where it is judged in this step S67 that the ratios of the simultaneously pressed direction keys are different, the flow shifts to step S68. When the ratios are equal, the flow shifts to step S69.

In step S68, the key which is not simultaneously pressed, that is, one key pressed many times is set as key data. Next, in step S70, the direction key set in this step S68 is set as transmission data.

On the other hand, in a case where the number of the times when one direction key is pressed is equal in step S69, priority is given to the initially pressed key, and the direction key is set. Thereafter, in step S70, the direction key set in step S69 is registered as the transmission data.

As described above, according to the fourth embodiment, even in a case where the adjacent keys are simultaneously pressed, when the predetermined number of the times is not reached, the data of the key can be transmitted in accordance with the pressed ratio.

### Fifth Embodiment

Next, a fifth embodiment of the present invention will be described.

A user has a difference in strength of a force to press an integral direction key. For example, for the user who presses the key weakly, an adjacent direction is not easily transmitted in some case. Conversely, as to the user who presses the key strongly, even when the user presses a position slightly deviating from a direction key existing in an electric circuit, the data of the adjacent direction is sometimes transmitted.

In a remote control device 10 of the present embodiment, since a direction button 16 is constituted of an integral component, in consideration of properties such as user's finger slide and pressing strength difference, a targeted direction needs to be detected more exactly. It is to be noted that as a reason why the strength difference is generated, since contacts 36a to 36d exist in four direction keys as integral components, an operation force differs with a case where these four contact places are pressed and a case where a place between four contacts is pressed, and therefore a difference is generated in user's operation.

To solve the problem, in the present fifth embodiment, to reduce the strength differences, the predetermined number of times by which it is judged whether or not the keys are simultaneously pressed can be varied.

It is to be noted that a constitution and a basic operation of a remote control device in the fifth embodiment are the same as those of the remote control device of the first embodiment shown in FIGS. 1 to 4. Therefore, the same part is denoted with the same reference numeral, drawing and description thereof are omitted, and only a different part will be described.

There will be described hereinafter an operation to calculate the predetermined number of the times in the remote control device in the fifth embodiment of the present invention with reference to a flowchart of FIG. 12.

When the present routine is started, first in step S81, it is judged whether or not there is a setting start key (not shown). Here, when there is not any input of the setting start key, the flow shifts to step S85, and it is judged that there is not any change in the predetermined number of the times. On the other hand, in a case where there is an input of the setting start key, the flow shifts to step S82, and it is judged whether or not there is an increase or reduce key (not shown). In a case where in steps S81 and S82, both of the keys are input, the flow shifts to step S85. When there is an input of one of the keys, the flow shifts to step S83.

Moreover, in a case where it is judged in step S83 that the increase key has been pressed, the flow shifts to step S84, and the predetermined number of the times is increased as much as “1”. On the other hand, in a case where it is judged in step S83 that the reduce key has been pressed, the flow shifts to step S86, and the predetermined number of the times is reduced as much as “1”.

As described above, according to the fifth embodiment, the predetermined number of the times for performing the judgment by the direction key can be changed in accordance with, for example, the user's pressing force.

According to the above first to fifth embodiments, direction key mechanism components, circuit constitution and software (algorithm) can realize the operation in directions that are not less than those of eight-direction-key contacts in a simple constitution in which a difference in operation feeling between the users has been eliminated.

Moreover, when the number of the contacts is large, spring forces of the resultant contact portions increase, and the operation of the integral key becomes heavy. However, since the number of the contacts is reduced owing to four direction keys, an operation force can be moderated.

As described above, according to the present invention, there can be provided a remote control device and an information reproducing device in which the direction key mechanism components, circuit constitution and software (algorithm) can realize the operation in directions that are not less than those of the present contacts without any difference in operation feeling between the users.

Moreover, the heavy operation feeling generated by a large number of contacts can be moderated by decreasing the number of the contacts.

The embodiments of the present invention have been described above, but besides the above embodiments, the present invention can variously be modified and implemented without departing from the scope of the present invention.

Furthermore, the above embodiments include various stages of inventions, and various inventions can be extracted by an appropriate combination of a plurality of disclosed constituting requirements. For example, even if several constituting requirements are deleted from all of the constituting requirements described in the embodiments, it is possible to solve the problems described in paragraphs of the problem to be solved by the invention, and effects described in paragraphs of the effect of the invention are obtained. In this case, even a constitution obtained by deleting the constituting requirements can be extracted as the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A remote control device equipped with a plurality of direction keys which are flat and which are equally divided, and in a case where the respective direction keys are individually operated, the remote control device being configured to transmit data in response to the operated direction key,
the remote control device comprising a control section in which in a case where one of the plurality of direction keys is operated simultaneously with one direction key adjacent to the direction key, control is performed to transmit data different from data of the direction key.

2. The remote control device according to claim 1, wherein the control section reads the direction key the predetermined number of times every predetermined time, and when the direction key is read in a case where the one direction key, and a first direction key and a second direction key adjacent to the one direction key, respectively, have simultaneously been operated, the control section transmits data of the one direction key as the center.

3. The remote control device according to claim 1, wherein the control section reads the direction key the predetermined number of times for a predetermined time, and in a case where simultaneous pressing indicating that the one direction key and a direction key adjacent to the one direction key are simultaneously operated is generated at a predetermined ratio or more in the predetermined time, the control is performed to transmit data different from data of the one direction key and the adjacent direction key.

4. The remote control device according to claim 3, wherein in the control section, in a case where the simultaneous pressing indicating that the one direction key and the direction key adjacent to the one direction key are simultaneously operated is generated at a ratio less than the predetermined ratio in the predetermined time, the control is performed to transmit data of a direction key having a larger ratio in the one direction key and the adjacent direction key.

5. The remote control device according to claim 4, wherein in the control section, in a case where the simultaneous pressing indicating that the one direction key and the direction key adjacent to the one direction key are simultaneously operated is generated at the ratio less than the predetermined ratio in the predetermined time, and the ratio of the one direction key is equal to that of the adjacent direction key, the control is performed to transmit data of a direction key first operated alone.

6. The remote control device according to claim 3, wherein in the control section, in a case where the one direction key and the direction key adjacent to the one direction key are simultaneously operated, the predetermined ratio in transmitting the data different from the data of the direction key is changeably controlled.

7. A remote control device, comprising: a plurality of direction keys which are concentrically circular and which are equally divided and which indicate a plurality of directions; a detection control section which detects data corresponding to the respective direction keys, in a case where the plurality of direction keys are individually operated; and a transmitting section which transmits the data detected by the detection control section to an external apparatus,
in a case where one first direction key of the plurality of direction keys is operated simultaneously with a second direction key adjacent to the first direction key, the detection control section being configured to output, to the transmitting section, data different from data of one of the first direction key and the second direction key,.

8. The remote control device according to claim 7, wherein the detection control section detects the direction key the predetermined number of times every predetermined time, and in a case where the one first direction key, and the second direction key and a third direction key adjacent to the first direction key, respectively, are simultaneously operated, control is performed to output, to the transmitting section, data of the first direction key as the center.

9. The remote control device according to claim 7, wherein the detection control section detects the direction key the predetermined number of times for a predetermined time, and in a case where simultaneous pressing indicating that the first direction key and the second direction key adjacent to the first direction key are simultaneously operated is generated at a predetermined ratio or more in the predetermined time, control is performed to output, to the transmitting section, data different from data of the first and second direction keys.

10. An information reproducing system comprising:
a remote control device equipped with a plurality of direction keys which are flat and which are equally divided, and in a case where the respective direction keys are individually operated, the remote control device being configured to transmit data in response to the operated direction key, the remote control device comprising a control section in which in a case where one of the plurality of direction keys is operated simultaneously with one direction key adjacent to the direction key, control is performed to transmit data different from data of the direction key; and
an information reproducing device which receives data of the remote control device and which performs processing in accordance with the data.
